(19) United States
(12) Patent Application Publication
(10) Pub. No.: US 2002/0148119 A1
(43) Pub. Date: Oct. 17, 2002

(54) CUTTING SHEET MATERIAL

(76) Inventor: MUMTAZ SHAH, MANCHESTER (GB)

Correspondence Address: EDWIN D SCHINDLER, PO BOX 966, CORAM, NY, 117270966

(21) Appl. No.: 09/403,796

(22) PCT Filed: Apr. 24, 1998
(86) PCT No.: PCT/GB98/01211

(30) Foreign Application Priority Data
Apr. 25, 1997 (GB) 9708327.2

(51) Int. Cl. B26B 27/00

(52) U.S. Cl. 30/290; 30/294

(57) ABSTRACT

Apparatus for cutting sheet material comprises a hand-manoeuvrable body (10) comprising separate superimposed parts (11, 12) with a gap (13) between in which a sheet material (23) can be received. The parts are physically connected only by a blade (14), and a pressure means (22), e.g. a freely rotatable wheel is provided to tension the sheet in front of the blade. The gap (13) may be sinusoidal for support, and tensioning of the sheet. A window (24) is provided for viewing the sheet in front of the blade (14).

This invention relates to apparatus for cutting sheet material.

For cutting sheet material such as paper or cloth plastics, including PVC etc., it is known to use cutting apparatus as an alternative to shears, scissors or a guillotine, which generally comprise a blade mounted to be slidable along some form of linear guide to produce a straight line cut, for example along a measured line for cutting paper or cloth to a required length. An example of such a cutter is the applicant's own British Patent, GB-A-2223976, wherein a blade runs along guides in an arm which is shaped to place the sheet under tension to enable a clean cut to be made by the blade.

Such cutters are useful for cutting sheets to predetermined sizes, for example for office use, or for cutting wallpaper to a required length. The blade is however constrained to move only along the guide, and thus cannot be used for cutting other than straight lines, or for example cutting out paper shapes, or cloth to a pattern, and heretofore scissors or shears have to be used for such purposes.

U.S. Pat. No. 3,835,536 (Marcoux) discloses a cutter for sheet material comprising a member which is intended to be guided by a straight edge such as a rule, and comprises a lower part and an upper part with a slot between them for guiding an e.g. paper sheet. The two parts are mechanically connected only by a cutter in the form of a razor blade, or a two-edged craft knife blade, and provide mating shaped surfaces for tensioning and guidance of the sheet.

An object of the invention is to provide apparatus for cutting sheet material which can be used to cut along other than straight line, and which preferably can be used freely, without restriction over the area of a sheet of material.

According to the invention, apparatus for cutting sheet material comprises a lower part for placing below a piece of sheet material, an upper part disposed above said lower part, with a gap between said upper and lower parts to receive said piece of sheet material, and a cutting blade secured in said upper and lower parts and extending across said gap and is characterised in that resilient pressure exerting means are provided mounted on one of the parts in the gap to bear on the other part, so that said piece of sheet material can be inserted between said pressure exerting means and said other part to tension the sheet material in the vicinity of the blade, to thus assist a clean cutting action.

The cutting blade or a holder and blade combination may be the only mechanical connection between the upper and lower parts, so that there is no obstruction to free movement of the apparatus when engaged with a sheet.

The pressure exerting means may also help to distribute a user's hand pressure on the upper part to the lower part without stress on the blade.

The underside of the lower part may be provided with runners or slides or optionally, rotatable members, to enable the lower part to be moved over a supporting surface such as a cutting table. The runners or slides may comprise inverted domes having a smooth finish, or rotatable members such as wheels or rollers mounted on the lower part, or recessed ball-bearings in sockets or races may be formed in the underside of the lower part.

The upper part may be shaped and configured to provide a handle suitable for manipulation of the apparatus, and to guide and move the apparatus as required.

An embodiment of apparatus according to the invention for cutting sheet material will now be described by way of example, with reference to the accompanying drawings, wherein:

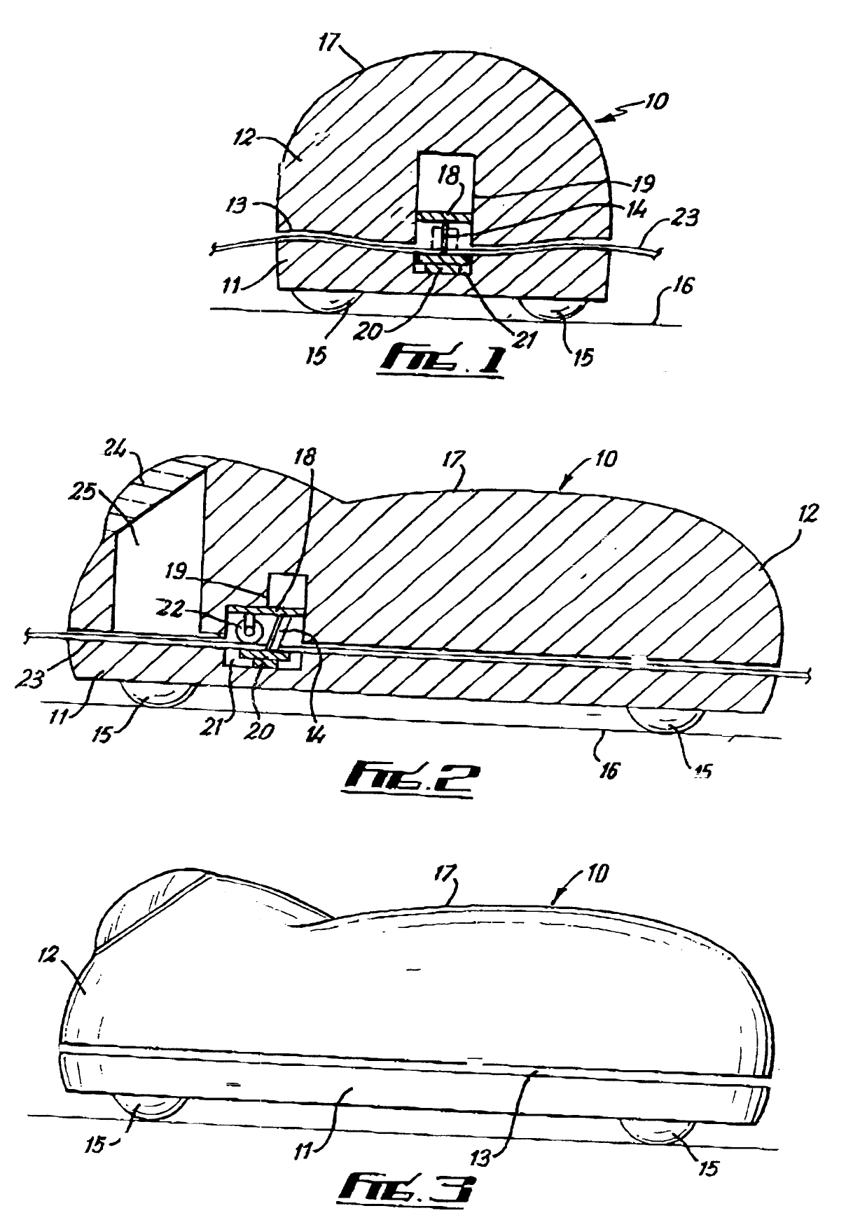

FIG. 1 is a transverse sectional view of the apparatus;

FIG. 2 is a longitudinal sectional view of the apparatus; and

FIG. 3 is a side view of the apparatus.

Apparatus according to the invention for cutting sheet material, as shown in the drawings, comprises an assembly 10, comprising a lower part 11, and an upper part 12. The upper and lower parts are assembled so that a gap 13 is present between them, and the only mechanical connection between the parts is a cutting blade 14 and its holder, which prevents the parts from being separated.

The lower part 11 is provided at its front and rear ends with respective groups of runners 15, in the form of inverted domes. These are preferably of a self lubricating plastics material such as PTFE, or of metal. These runners 15 enable the lower part 11 to be moved freely about a surface 16 such as a table.

The upper part 12 is shaped to provide a hand grip surface 17. Blade 14 is held at its upper end in a holder 18 secured in a recess 19 in the upper part 12. The lower end of blade 14 is held in a further holder 20 secured in a recess 21 in the lower part 11. The blade 14 can be removed and replaced in the holders, for example to replace broken or blunted blades.

A freely rotatable pressure wheel 22 is carried by the holder 18. This tensions sheet material such as 23 immediately in front of blade 14.

Sheet 23 is of material such as paper and is inserted into the gap 13 until the edge of the sheet abuts the cutting edge of blade 14, and wheel 2 presses on the sheet, pressing it against the upper surface of lower part 11, and subjecting the sheet 23 to tension in the zone of the blade 14. This enables a clean cut to be made by the blade as the apparatus is moved over the support 16.

The gap 13 is contoured as shown in the drawings to provide ridges on the lower part 11 and corresponding recesses in the upper part 12. This produces a sinusoidal-like path for the sheet 23 across the blade, and helps to tension the sheet and provide for support of the upper part by the lower part.

The weight exerted by the user's hand is passed on to the lower part 11 to each side of the blade rather than through the blade 14, since otherwise the strain on the blade would lead to frequent breakages.

As there is no obstruction to the sheet 23 other than the blade and its holder in the gap 13, the apparatus can be moved freely over the support surface 16, cutting along any measured lengths and along straight ruled lines, for example in cutting wrapping paper to length, but also to follow curves etc. as in cutting out paper patterns, or cutting cloth to a pattern for dressmaking; or in a non-straight edge feature such as a moulding.

A magnifying window 24 is provided in the upper part, with a space 25 in the upper part allowing visual inspection of the sheet 23 immediately in front of the blade 14.

The above is one example of a possible form of apparatus according to the invention, and many of the details may be varied within the scope of the invention as defined in the amended claims. For example, instead of a wheel 14, rollers, dome head bearing members or recessed ball-bearings may be used to allow the lower part to move freely.

The number and placing of the pressure exerting members 22 may also be varied, most probably by providing a greater number, to transmit substantially all the hand pressure load to the lower part without stressing the blade.

Further, the shape and configuration of the upper part may be varied to provide a suitable or comfortable hand hold in different styles and sizes for single or double-handed operation, for various sizes of hands, or a joystick style handle used.

1. Apparatus for cutting sheet material, comprising a lower part (11) for placing below a piece of sheet material (23), an upper part (12) disposed above said lower part, a gap (13) between said upper and lower parts to receive said piece of sheet material, and a cutting blade (14) secured in said upper and lower parts and extending across said gap characterised in that pressure exerting means (22) are provided on one of the parts (11 or 12) in the gap (13) to bear on the other part (12 or 11), so that said piece of sheet material (23) can be inserted between the pressure exerting means (22) and the other part to tension the sheet material in the vicinity of the blade (14).

2. Apparatus according to claim 1 characterised in that said cutting blade (14) or a holder and blade combination (18, 14) is the only mechanical connection between said upper and said lower parts, whereby there is no obstruction to free movement of the apparatus when engaged with a sheet.

3. Apparatus according to claim 3 characterised in that said pressure exerting means comprises a freely rotatable wheel (22), positioned immediately in front of the blade (14).

4. Apparatus according to any preceding claim characterised in that the upper face of said lower part (11) and the lower face of said upper part (12) are shaped to provide matching sinusoidal surfaces for support of the upper part and tensioning of the sheet.

5. Apparatus according to any preceding claim, wherein a window (24) is provided in one part for viewing the sheet immediately in front of the blade (14).
